(19) United States
(12) Patent Application Publication
(10) Pub. No.: US 2026/0031320 A1
(43) Pub. Date: Jan. 29, 2026

(54) METHOD FOR MANUFACTURING ELECTRODE ASSEMBLY FOR ALL-SOLID-STATE BATTERY

(71) Applicants: Hyundai Motor Company, Seoul (KR); Kia Corporation, Seoul (KR)

(72) Inventors: Ju Yeon Lee, Hwaseong (KR); Jae Hyun Rim, Hwaseong (KR); Gyeong Jun Chung, Hwaseong (KR); Yoon Gon Kim, Hwaseong (KR); Jong Jung Kim, Hwaseong (KR); Yoon Jae Han, Hwaseong (KR); Chang Young Choi, Hwaseong (KR); Sang Mo Kim, Hwaseong (KR); Dong Hyun Kim, Hwaseong (KR)

(21) Appl. No.: 19/092,502

(22) Filed: Mar. 27, 2025

(30) Foreign Application Priority Data
Jul. 29, 2024 (KR) 10-2024-0100377

(51) Int. Cl. H01M 4/04; H01M 4/505; H01M 4/525; H01M 4/583

(52) U.S. Cl. CPC H01M 4/0404; H01M 4/0435; H01M 4/0471; H01M 4/505; H01M 4/525; H01M 4/583; H01M 2300/0068

(57) ABSTRACT

An electrode assembly is produced by partially drying an electrode slurry (20-50% dryness), then coating a solid electrolyte slurry with controlled viscosity (1,000-10,000 cP) and solids content (40-80 wt %). Both slurries are dried at 60-120° C., while the ratio of solid electrolyte slurry viscosity to electrode slurry viscosity (0.2-1.0) reduces interlayer mixing. The degree of dryness is determined by comparing residual solvent in the partially dried layer to the original slurry. This approach yields a uniform interface between the electrode and electrolyte. A corresponding method for an all-solid-state battery encloses the resulting electrode assembly, along with an anode layer, in a battery casing, ensuring enhanced interface stability.

### CROSS-REFERENCE TO RELATED APPLICATION

This application claims under 35 U.S.C. § 119 (a) the benefit of Korean Patent Application No. 10-2024-0100377, filed in the Korean Intellectual Property Office on Jul. 29, 2024, the entire contents of which are incorporated herein by reference.

### BACKGROUND

### Technical Field

The present disclosure relates to a method for manufacturing an electrode assembly employed in an all-solid state battery, and more particularly, relates to a method for manufacturing an electrode assembly of an all-solid state battery, capable of applying and drying a solid electrolyte slurry in the state that an electrode slurry is not completely dried, thereby improving an interface characteristic, such that the performance of an electrode and the performance of the all-solid state battery including the electrode are improved.

### Background

Recently, studies and researches have been conducted on various batteries to overcome the limitation of a lithium secondary battery in the capacity of a battery, the stability of the battery, the power of the battery, the increase in the size of the battery, or the decrease in the size of the battery. Among them, an all-solid-state battery refers to a battery having a solid electrolyte instead of a liquid electrolyte having been employed in conventional lithium secondary batteries. According to the all-solid-state battery, as a flammable solvent is not used inside the battery, the risk of firing or explosion, which has occurred due to the decomposition reaction of the conventional electrolyte, is removed, so stability is significantly improved.

The all-solid-state battery is configured by forming a stack structure including a cathode, an anode, and a solid electrolyte layer interposed between the cathode and the anode. Unlike the lithium-ion battery of transferring lithium ions through the contact between an electrolyte and an active material, the all-solid-state battery transfers the lithium ions through the contact between a solid electrolyte and a solid active material. Accordingly, in the all-solid-state battery, the contact of solid components of the solid electrolyte and the solid active material should be maximized to optimize the transfer path of the lithium ions. When the contact between the solid electrolyte and the solid active material is enhanced, an interface resistance is reduced to reduce an internal resistance of a cell, such that the use of an active material is increased, thereby improving the endurance of the cell.

Meanwhile, various manners have been known to make the contact between an electrode layer, which includes an active material, and a solid electrolyte layer which includes an electrolyte. A representative manner among the various manners is to make the contact between the above layers by transferring the solid electrolyte layer onto the electrode layer. However, when such a manner is applied, the electrode layer or the electrolyte layer may be cracked under higher pressure, or the electrolyte layer may fail to be sufficiently transferred onto the electrode layer under lower pressure. In addition, such a manner is performed in the state that all the electrode layer and the solid electrolyte layer are dried to be in a solid state. Accordingly, as the electrode layer and the solid electrolyte layer fail to sufficiently make contact, pores are inevitably formed.

A manner for coating a solid electrolyte slurry onto an electrode layer is derived to complement the problem of the above manner. A solid electrolyte in a liquid state is coated onto the electrode layer, and the result is dried, thereby making a relatively-excellent contact state between the solid electrolyte layer and the electrode layer. However, even when the manner is applied, a portion of a solvent, which is not drained out in the process of preparing the electrode layer, moves, in a gas state, onto an upper portion of the electrolyte layer when the electrolyte layer is dried, thereby making a top surface of the electrolyte layer irregular. As another manner, there is a wet-on-wet process of coating an electrode slurry onto a current collector, coating a solid electrolyte slurry onto a result, which is not dried, and drying the solid electrolyte slurry together with the electrode slurry. However, even the wet-on-wet process has a disadvantage in which a portion of an active material of the electrode layer is delaminated from the electrode layer, as the electrode layer and the electrolyte layer are excessively mixed on the interface between the electrode layer and the electrolyte layer, thereby making the difference in an N/P value between a designed cell and a real cell, so the cell characteristic is deteriorated.

Accordingly, there is required to develop a novel electrode assembly for an all-solid state battery, capable of solving the above-described disadvantages of conventional manners in manufacturing the all-solid state battery, while maximizing the contact between the electrode layer and the solid electrolyte layer and minimizing a resistance, on the interface between the electrode layer and the solid electrolyte layer.

### SUMMARY

The present disclosure has been made to solve the above-mentioned problems occurring in the prior art while advantages achieved by the prior art are maintained intact.

Some embodiments of the present disclosure provide a method for manufacturing an electrode assembly of an all-solid-state battery.

More specifically, some embodiments of the present disclosure provide a method for manufacturing an electrode assembly for an all-solid-state battery, in which an electrode slurry is coated on a current collector, and the result is dried to form an electrode layer. In this case, in the state that the electrode slurry is incompletely dried, a solid electrolyte slurry is coated on the electrode slurry, and the result is dried to form a solid electrolyte layer. Accordingly, the inter-layer mixing may be minimized on the interface between the electrode layer and the solid electrolyte layer, thereby maximizing the contact on the interface, such that the endurance of the electrode and the cell are enhanced.

The technical problems to be solved by the present disclosure are not limited to the aforementioned problems, and any other technical problems not mentioned herein will be clearly understood from the following description by those skilled in the art to which the present disclosure pertains.

To solve the problem, the present disclosure provides a method for manufacturing an electrode assembly of an all-solid-state battery.

In more detail, (1) the present disclosure provides a method for manufacturing an electrode assembly, which includes coating an electrode slurry on an electrode current collector, drying the electrode slurry to a degree of dryness ranging from 20% to 50% to form an electrode layer, coating a solid electrolyte slurry on the electrode layer formed, and drying the solid electrolyte slurry. The degree of the dryness is calculated through following Equation 1,

$$The degree of dryness = \{ 1 - ( content of solvent in the electrode layer formed after the partial drying ) / ( content of solvent in the coated electrode slurry ) \} * 100 \% . \qquad [ Equation 1 ]$$

(2) The present disclosure provides the method for manufacturing the electrode assembly, in which a solid content of the solid electrolyte slurry ranges from 40 wt % to 80 wt % in (1).

(3) The present disclosure provides the method for manufacturing the electrode assembly, in which a viscosity of the electrode slurry ranges from 1,000 cP to 10,000 cP, in (1) or (2).

(4) The present disclosure provides the method for manufacturing the electrode assembly, in which the partially drying the electrode slurry to a degree of dryness ranging from 20% to 50% is performed at a temperature ranging from 60° C. to 120° C., in any one of (1) to (3).

(5) The present disclosure provides the method for manufacturing the electrode assembly, in which a solid content of the solid electrolyte slurry ranges from 40 wt % to 80 wt %, in any one of (1) to (4).

(6) The present disclosure provides the method for manufacturing the electrode assembly, in which a viscosity of the solid electrolyte slurry ranges from 1,000 cP to 10,000 cP, in any one of (1) to (5).

(7) The present disclosure provides the method for manufacturing the electrode assembly, in which a ratio of a viscosity of the solid electrolyte slurry to a viscosity of the electrode slurry ranges from 0.2 to 1.0, in any one of (1) to (6).

(8) The present disclosure provides the method for manufacturing the electrode assembly, in which the drying the solid electrolyte slurry is performed at a temperature ranging from 60° C. to 120° C., in any one of (1) to (7).

In some embodiments, a method for manufacturing an electrode assembly comprises: providing an electrode slurry having a solid content of about 40 wt % to about 80 wt % and a viscosity of about 1,000 cP to about 10,000 cP at 25° C.; coating the electrode slurry on a current collector; partially drying the coated electrode slurry so that a degree of dryness is from about 20% to about 50% to form an incompletely dried electrode layer; providing a solid electrolyte slurry having a solid content of about 40 wt % to about 80 wt % and a viscosity of about 1,000 cP to about 10,000 cP at 25° C.; coating the solid electrolyte slurry on the incompletely dried electrode layer; drying the solid electrolyte slurry at a temperature ranging from about 60° C. to about 120° C.; ensuring that a ratio of the solid electrolyte slurry viscosity to the electrode slurry viscosity is from about 0.2 to about 1.0; and calculating the degree of dryness using the formula:

$$Degree of dryness = \{ 1 - ( content of solvent in the electrode layer after partial drying ) / ( content of solvent in the coated electrode slurry ) \} * 100 \% .$$

The method may perform the partial drying at about 60° C. to about 120° C. until the degree of dryness is about 20% to 50%.

The method may further comprise, before coating the electrode slurry, preparing it by mixing a cathode active material, a sulfide-based solid electrolyte powder, a binder, a conductive material, and a solvent.

The method may include controlling the viscosity ratio (solid electrolyte slurry to electrode slurry) to about 0.2 to 1.0 at 25° C., where the solid electrolyte slurry also comprises a sulfide-based solid electrolyte, a binder, and a solvent.

The method may form the electrode layer as a cathode layer having an NCM-type cathode active material with an average particle size of about 1 μm to about 50 μm.

The method may dry the solid electrolyte slurry at about 60° C. to about 120° C. for about 1 to 30 minutes.

The method may control the partial drying to achieve approximately 30% dryness, thereby reducing inter-layer mixing while preventing surface irregularities on the solid electrolyte layer.

The method may subject the completed electrode assembly to a calendering step under about 1 MPa to about 50 MPa of pressure at a temperature from about 25° C. to about 80° C.

In some embodiments, a method for producing an all-solid-state battery includes: manufacturing an electrode assembly as described above; forming an anode layer, stacking the electrode assembly and the anode layer so that the solid electrolyte layer faces the anode; and enclosing or sealing the stacked assembly in a battery casing to construct the all-solid-state battery.

The method may form the anode layer by coating an anode slurry comprising a carbon-based active material or a metal-based active material, and drying at about 60° C. to 120° C.

The method may incorporate a separator layer between the electrode assembly and the anode layer, where the separator layer is formed from a solid electrolyte film of about 5 μm to 50 μm thickness.

The method may include an initial charging or formation cycle at room temperature to about 60° C. to stabilize the interface between the electrode assembly and the anode layer.

As discussed, the method and system suitably include use of a controller or processer.

### BRIEF DESCRIPTION OF THE DRAWINGS

The above and other objects, features and advantages of the present disclosure will be more apparent from the following detailed description taken in conjunction with the accompanying drawings:

FIG. 1 is a view obtained by observing a surface of a solid electrolyte layer of an electrode assembly according to Example 1 of the present disclosure;

FIG. 2 is a view obtained by observing a surface of a solid electrolyte layer of an electrode assembly according to Comparative example 1 of the present disclosure;

FIG. 3 is a view obtained by observing a surface of a solid electrolyte layer of an electrode assembly according to Comparative example 3 of the present disclosure;

FIG. 4 is a view obtained by observing the cross-sectional of an electrode assembly according to Example 1 of the present disclosure, in the form of an SEM image;

FIG. 5 is a view obtained by observing the cross-sectional of an electrode assembly according to Example 2 of the present disclosure, in the form of an SEM image; and

FIG. 6 is a view obtained by observing the cross-sectional of an electrode assembly according to Comparative example 2 of the present disclosure, in the form of an SEM image.

### DETAILED DESCRIPTION

Hereinafter, the present disclosure will be described in more detail for the understanding of the present disclosure.

In this case, terms and words used in the present specification and the claims shall not be limitedly interpreted as commonly-used dictionary meanings, but shall be interpreted as to be relevant to the technical scope of the present disclosure based on the fact that the inventor may properly define the concept of the terms to explain the present disclosure in best ways.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “viscosity” used herein refers to a fluid's internal resistance to flow, typically measured in centipoise (cP) at a specified temperature (for example, 25° C.) using a viscometer such as a Brookfield instrument or an equivalent industry-standard device.

The term “partial dryness” used herein refers to an intermediate level of drying (for instance, 20% to 50% dried), in which the slurry has not reached 0% solvent content but remains partially wet, so that further processing—such as applying a solid electrolyte layer—can occur while still minimizing inter-layer mixing.

The term “NCM-type active material” used herein refers to a lithium mixed-metal oxide cathode material containing nickel (Ni), cobalt (Co), and manganese (Mn), often written as Li(Ni_xCo_yMn_z)O₂, where x, y, and z are positive numbers typically summing to 1 and may be varied to achieve desired electrochemical properties.

The term “sulfide-based solid electrolyte” used herein refers to a lithium-ion-conducting solid material composed largely of sulfur-containing compounds. These electrolytes provide ion conduction in an all-solid-state battery without the use of liquid solvents.

Method for Manufacturing an Electrode Assembly for all-Solid State Battery

The present disclosure provides a method for manufacturing an electrode assembly, which includes coating an electrode slurry on an electrode current collector (S1), drying the electrode slurry to a degree of dryness ranging from 20% to 50% to form an electrode layer (S2), coating a solid electrolyte slurry on the electrode layer formed (S3), and drying the solid electrolyte slurry (S4). The degree of the dryness is calculated through following Equation 1,

$$The degree of dryness = \{ 1 - ( content of solvent in the electrode layer formed after drying ) / ( content of solvent in the electrode slurry coated ) \} * 100 \% . \qquad [ Equation 1 ]$$

According to a transferring manner among manners known for manufacturing the electrode assembly for the all-solid state battery, as an electrode layer in a solid state and a solid electrolyte layer are allowed to make contact with each other and pressure is applied to the result, each of the electrode layer and the solid electrolyte layer may be cracked in the process of applying the pressure. In addition, as the incomplete contact is significantly made on the interface between the electrode layer and the solid electrolyte layer, pores are formed. According to the manner for forming the solid electrode layer by forming the electrode layer, coating the solid electrolyte slurry onto the electrode layer, and drying the result, the solvent remaining on the electrode layer may be vaporized in the process of drying the solid electrolyte layer to make an upper region of the solid electrolyte layer irregular. Finally, according to a wet-on-wet process of coating an electrode slurry onto a current collector, coating a solid electrolyte slurry onto a result, which is not dried, and drying the electrode layer and the solid electrolyte layer, as the mixing of electrode layer and the electrolyte layer is caused on the interface between the electrode layer and the solid electrolyte layer, to delaminate the active material, thereby making the difference of an N/P value from a designed value.

Meanwhile, according to the method for manufacturing the electrode assembly of the present disclosure, the electrode layer is formed using the electrode slurry, the solid electrolyte layer is formed by coating the solid electrolyte slurry onto the electrode layer, and drying the result, in the state that the electrode slurry is partially dried without being completely dried. Accordingly, the contact between the electrode layer and the solid electrolyte layer may be maximized on the interface between the electrode layer and the solid electrolyte layer, and the inter-layer mixing between the electrode layer and the solid electrolyte layer may be minimized, thereby improving the endurance of the cell.

Hereinafter, the method for manufacturing the electrode assembly of the all-solid-state battery will be described in more detail.

### Forming Electrode Layer (S1 and S2)

According to the method for manufacturing an electrode assembly of the all-solid-state battery of the present disclosure, an electrode layer is formed using an electrode slurry, and a portion of a solvent of the electrode slurry is removed by intentionally adjusting a drying process. More specifically, the method for manufacturing an electrode assembly of the all-solid-state battery of the present disclosure includes coating the electrode slurry on the electrode current collector (S1), and drying the electrode slurry to a degree of dryness ranging from 20% to 50% and forming the electrode layer (S2).

According to the present disclosure, the degree of dryness may be defined through following Equation 1.

$$The degree of dryness = \{ 1 - ( content of solvent in the electrode layer formed after drying ) / ( content of solvent in the electrode slurry coated ) \} * 100 \% . \qquad [ Equation 1 ]$$

The degree of dryness is an index indicating the degree in which the electrode slurry coated is dried. The degree of dryness of 0% indicates that the electrode slurry has never undergone the drying process after being coated. The degree of dryness of 100% indicates that the electrode slurry is dried until the solvent contained in the electrode slurry is completely removed from the electrode slurry after the electrode slurry is coated. According to the method for manufacturing the electrode assembly of the present disclosure, after the drying process is performed until the degree of dryness ranges from 20% to 50%, preferably, at least 20%, or at least 25% and at most 45%, at most 40%, or at most 35%, the solid electrolyte slurry is coated in the procedure, which is to be described below, in the state that the solvent contained in the electrode slurry is not completely removed.

When the solid electrolyte slurry is coated in the state that the degree of dryness ranges from 20% to 50%, inter-layer mixing, which is caused when the solid electrolyte slurry is coated in the state that the electrode slurry is never dyed, may be minimized to prevent the active material, which is provided in the electrode layer, from being delaminated. In addition, the top surface of the solid electrolyte layer may be prevented from being irregular due to air bubbles which may be produced from a lower portion of the electrode layer when the solid electrolyte slurry is coated in the state that the electrode slurry is completely dried. When the solid electrolyte slurry is coated in the state that the drying is performed to the extent that the degree of dryness fails to reach 20%, the inter-layer mixing described above is made to cause a portion of the active material to be delaminated. Accordingly, the difference between the N/P value and the designed value is made such that the cell characteristic is deteriorated. On the contrary, when the solid electrolyte slurry is coated in the state that the drying is performed to the extent that the degree of dryness is at least 50%, the top surface of the solid electrolyte layer may be irregular.

Meanwhile, in calculating the degree of dryness, the solvent content in the electrode layer can be calculated through the weight difference before and after drying a 4 cm×4 cm punched electrode after completely drying it at 100° C. for 2 hours, and the solvent content in the electrode slurry can be calculated through the weight difference before and after drying 2 g of the slurry after completely drying it at 100° C. for 2 hours.

Meanwhile, the electrode slurry may include an electrode active material, a solid electrolyte, a binder, a dispersant, and a solvent.

The electrode active material may include a cathode active material, or an anode active material typically employed in an electrode for the all-solid-state battery, and the type of the active material is not specifically limited.

More specifically, the cathode active material may be an oxide active material or a sulfide active material.

The oxide active material may be a rock salt type active material, such as LiCoO₂, LiMnO₂, LiNiO₂, LiVO₂, Li₁₊ₓNi_{1/3}CO_{1/3}Mn_{1/3}O₂, Li[NiₓCo_{y}Mn_{z}Mv]O₂ (in the above equation, ‘M’ is any one or at least two types of elements selected from the group consisting of transition metals including Al, Ga, and In; 0.3 [symbol] x<1.0, 0≤y, z≤0.5, 0≤v≤0.1, x+y+z+v=1), a spinel type active material such as LiMn₂O₄ or Li(Ni_{0.5}Mn_{1.5})O₄, a reverse spinel type active material such as LiNiVO₄, or LiCoVO₄, an olivine-type active material, such as LiFePO₄, LiMnPO₄, LiCoPO₄, or LiNPO₄, a silicon-containing active material such as Li₂FeSiO₄, or Li₂MnSiO₄, a rock salt type active material, such as LiNi_{0.8}Co(_{0.2-x})AlₓO₂(0<x<0.2), which is obtained by substituting a portion of the transition metal with a heterogeneous metal, a spinel-type active material, such as Li₁₊ₓMn_{2-x-y}MyO₄(‘M’ is at least one of Al, Mg, Co, Fe, Ni, and Zn; 0<x+y<2), which is obtained by substituting a portion of the transition metal with a heterogeneous metal, or lithium titanate such as Li₄Ti₅O₁₂. The sulfide active material may be copper Chevrel, iron sulfide, cobalt sulfide, or nickel sulfide.

Meanwhile, the anode active material may be a carbon active material or a metal active material.

The carbon active material may be graphite, such as mesocarbon microbeads (MCMB) and highly oriented graphite (HOPG), or amorphous carbon such as hard carbon, and soft carbon. The metal active material may be In, Al, Si, Sn, and an alloy containing at least one element of In, Al, Si, and Sn.

In addition, the present disclosure is not specifically limited. For example, the average particle size (D₅₀) of the electrode active material may range from 1 μm to 50 μm, and more preferably, the average particle size (D₅₀) of the electrolyte active material may be at least 1 μm, at least 2 μm, or at least 3 μm while being at most 45 μm, at most 40 μm, at most 35 μm, at most 30 μm, at most 25 μm, at most 20 μm, at most 15 μm, at most 10 μm, or at most 7 μm. In addition, the density of the electrode active material may range from 1 g/cm³ to 10 g/cm³, and more preferably, at least 1.5 g/cm³, or at least 2 g/cm³, while being at most 8 g/cm³, at most 5 g/cm³, or at most 3 g/cm³.

The content of the electrode active material in the electrode slurry may range from 40 wt % to 90 wt %, and preferably, may be at least 50 wt %, at least 55 wt %, or at least 60 wt %, and while being at most 88 wt %, at most 85 wt %, or at most 80 wt %.

The solid electrolyte may be an oxide-based solid electrolyte or a sulfide-based solid electrolyte, and preferably a sulfide-based solid electrolyte. The solid electrolyte may have a lithium-ion conductivity of 0.3 mS/cm or more.

The sulfide-based solid electrolyte is not particularly limited, but may, include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where ‘m’ and ‘n’ are positive numbers, ‘Z’ is one of Ge, Zn and Ga), Li₂S—GeS₂, Li₂S—SiS₂—Li₃PO₄, Li₂S—SiS₂-LixMOy (where ‘x’ and ‘y’ are positive numbers, M is one of P, Si, Ge, B, Al, Ga, In), or Li₁₀GeP₂S₁₂.

In addition, the present disclosure is not specifically limited. For example, the average particle size (D₅₀) of the solid electrolyte may range from 0.01 μm to 20 μm, and more preferably, the average particle size (D₅₀) may be at least 0.05 μm, at least 0.1 μm, or at least 0.5 μm while being at most 10 μm, at most 5 μm, or at most 3 μm. In addition, the density of the electrode active material may range from 0.01 g/cm³ to 5 g/cm³, and more preferably, at least 0.2 g/cm³, or at least 0.3 g/cm³, while being at most 3 g/cm³, at most 1 g/cm³, or at most 0.7 g/cm³.

The content of the solid active material in the electrode slurry may range from 10 wt % to 60 wt %, and preferably, may be at least 12 wt %, at least 15 wt %, or at least 17 wt %, and while being at most 55 wt %, at most 50 wt %, or at most 45 wt %.

The type of the binder is not specifically limited. Specifically, the binder may be at least one selected from the group consisting of nitrile butadiene rubber (NBR), butadiene rubber (BR), hydrogenated nitrile butadiene rubber (HNBR), polystyrene (PS), styrene butadiene rubber (SBR), polymethyl methacrylate (PMMA), polyethylene oxide (PEO), polytetrafluoroethylene (PTFE), polyacrylonitrile (PAN), polyvinylidene fluoride (PVDF), and copolymer of polyvinylidene fluoride and polyhexafluoropropylene (PVDF-HFP), and may employ a material obtained by modifying a functional group of a binder arranged above.

The average particle size of the binder may be at most 500 μm, and preferably, may be at least 50 μm, at least 100 μm, or at least 150 μm while being at most 400 μm, at most 350 μm, or at most 250 μm. In addition, the density of the binder may range from 1 g/cm³ to 10 g/cm³, and preferably, at least 1.5 g/cm³, or at least 2 g/cm³, while being at most 2 g/cm³, at most 8 g/cm³, at most 5 g/cm³, or at most 3 g/cm³.

The content of the binder in the electrode slurry may range from 0.5 wt % to 5 wt %, and preferably, may be at least 1 wt %, at least 1.25 wt %, or at least 1.5 wt %, while being at most 4 wt %, at most 3.5 wt %, or at most 3 wt %.

The conductive material is not specifically limited. The conductive material may be a dot-shaped conductive material or a line-shaped conductive material. More specifically, the conductive material may be at least one selected from the group consisting of carbon black, conducting graphite, ethylene black, graphene, and carbon nanotube. In addition, the average density of the conductive material may range from 1 g/cm³ to 5 g/cm³, and preferably, at least 1.2 g/cm³ or at least 1.5 g/cm³, while being at most 4 g/cm³, at most 3.5 g/cm³, or at most 3 g/cm³.

The content of the conductive material in the electrode slurry may range from 0.5 wt % to 5 wt %, and preferably, may be at least 1 wt %, at least 1.25 wt %, or at least 1.5 wt %, while being at most 4 wt %, at most 3.5 wt %, or at most 3 wt %.

The dispersant is not specifically limited as long as the dispersant is employed to prepare the electrode slurry.

The solvent may include at least one selected from the group consisting of xylene, butyl butyrate, hexyl butyrate, N-methyl-2-pyrrolidinone, tetrahydrofuran, acrylonitrile, and the combination thereof.

According to the present disclosure, the solid content of the electrode slurry may range from 40 wt % to 80 wt %, and preferably, may be at least 45 wt %, at least 50 wt %, or at least 55 wt %, and while being at most 75 wt %, at most 70 wt %, or at most 65 wt %. In addition, the viscosity of the electrode slurry may, at the temperature of 25° C., range from 1,000 cP to 10,000 cP, and preferably, may be at least 2,000 cP, at least 3,000 cP, or at least 4,000 cP while being at most 9,000 cP, at most 8,000 cP, or at most 7,000 cP. When the content and the viscosity of the electrode slurry satisfy the above condition, the electrode slurry may be smoothly coated on the current collector.

According to the present disclosure, the drying process in ‘S2’ may be performed at the temperature ranging from 60° C. to 120° C., and preferably may be performed at the temperature of at least 70° C., at least 80° C., or at least 90° C. while being at most 115° C., at most 110° C., or at most 105° C. When the temperature in the drying step is within the above-described condition, the degree of dryness may be smoothly adjusted.

Meanwhile, the current collector employed in the present step may include a material varied depending on whether the electrode is a cathode or an anode. For example, the current collector may include iron, copper, stainless steel, aluminum, nickel, titanium, calcined carbon, a material which is obtained by surface-treating iron, copper, stainless steel, aluminum, nickel, titanium, calcined carbon with carbon, nickel, titanium or silver, and/or the alloy thereof. In addition, the electrode current collector may have the form of a film, a sheet, a foil, a net, a porous body, a foam, or a non-woven body.

### Forming Solid Electrolyte Layer (S3 and S4)

After forming the electrode layer incompletely dried in the previous step, the solid electrolyte layer is formed on the electrode layer, thereby manufacturing the electrode assembly for the all-solid-state battery.

According to the present disclosure, the solid content of the electrode slurry may range from 40 wt % to 80 wt %, and preferably, may be at least 45 wt %, at least 50 wt %, or at least 55 wt %, and while being at most 75 wt %, at most 70 wt %, or at most 65 wt %. In addition, the viscosity of the solid electrolyte slurry may, at the temperature of 25° C., range from 1,000 cP to 10,000 cP, and preferably, may be at least 2,000 cP, at least 3,000 cP, or at least 4,000 cP while being at most 9,000 cP, at most 8,000 cP, or at most 7,000 cP.

In addition, a ratio (a solid electrolyte slurry viscosity/an electrode slurry viscosity) of a viscosity of the solid electrolyte slurry to a viscosity of the electrode slurry described above ranges from 0.2 to 1.0, and preferably, may be at least 0.3, at least 0.4, or at least 0.5, while being at most 0.9, at most 0.8, or at most 0.7. When the ratio of the viscosity of the solid electrolyte slurry to the viscosity of the electrode slurry satisfies the above-described condition, the solid electrolyte slurry may be smoothly coated onto the electrode layer, which is partially dried, without flowing down along the electrode layer.

According to the present disclosure, the drying process in ‘S4’ may be performed at the temperature ranging from 60° C. to 120° C., and preferably may be performed at the temperature of at least 70° C., at least 80° C., or at least 90° C. while being at most 115° C., at most 110° C., or at most 105° C. When the temperature in the drying step is within the above-described condition, a remaining solvent may be efficiently removed.

The solid electrolyte slurry used in the present step may contain ingredients the same as a solid electrolyte, a binder, a dispersant, and a solvent among ingredients contained in the electrode slurry described above.

The electrode assembly manufactured through the method for manufacturing the electrode assembly of the all-solid-state battery according to the present disclosure, may be a cathode assembly or an anode assembly, and preferably, may be a cathode assembly.

Hereinafter, an example of the present disclosure will be described in more detail. However, the following example is provided only for the illustrative purpose, and the scope of the present disclosure is not limited to the following example.

### Material

An NCM-type cathode active material was used as the cathode active material, a sulfide-based solid electrolyte was used as a solid electrolyte, and an NBR was used as the binder. Super C65 was used as the conductive material, disperBYK-2155 was used as a dispersant, and butyl butyrate was used a slurry solvent.

### Example 1

The electrode slurry was prepared by mixing the cathode active material, the solid electrolyte, the binder, the conductive material, the dispersant, and the solvent of the materials. The viscosity of the prepared electrode slurry was measured to 5,000 cP at the temperature of 25° C. After coating the electrode slurry on an aluminum base serving as the current collector, the result was dried at the temperature of 90° C. for three minutes, such that the degree of dryness becomes 30%.

Thereafter, the solid electrolyte slurry was prepared by mixing the solid electrolyte, the binder, the dispersant, and the solvent the same as the solid electrolyte, the binder, the dispersant, and the solvent contained in the electrode slurry. The viscosity of the prepared solid electrolyte slurry was measured to 4,000 cP at the temperature of 25° C. After coating the solid electrolyte slurry on the electrode layer prepared above, the result was dried at the temperature of 95° C. for 10 minutes, thereby manufacturing the cathode assembly.

### Example 2

The cathode assembly was prepared in the same manner as that of Example 1, except that the drying process was performed at the temperature of 90° C. for two minutes after coating the electrode slurry, such that the degree of dryness is 20%.

### Comparative Example 1

The cathode assembly was prepared in the same manner as that of Example 1, except that the drying process was performed at the temperature of 90° C. for ten minutes after coating the electrode slurry, such that the degree of dryness is 100%.

### Comparative Example 2

The cathode assembly was prepared by coating and drying a solid electrolyte the same as that in Example 1, without performing the drying after coating the electrode slurry in Example 1.

### Comparative Example 3

The cathode assembly was prepared in the same manner as that of Example 1, except that the drying process was performed at the temperature of 90° C. for seven minutes after coating the electrode slurry, such that the degree of dryness is 70%.

### Experimental Example 1: Observation Surface of Solid Electrolyte Layer after Preparing Electrode

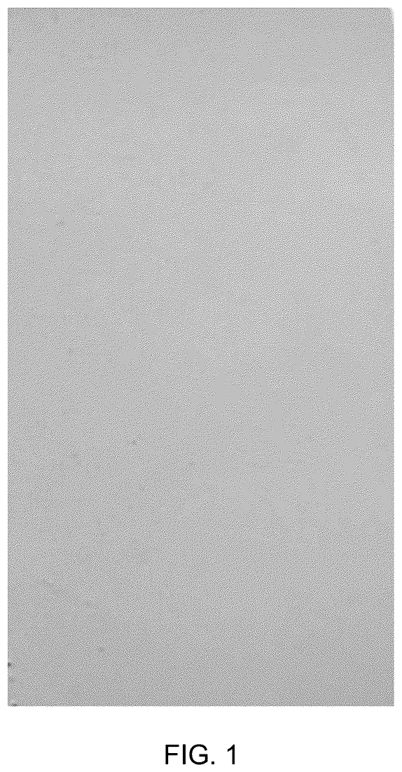

FIGS. 1 to 3 illustrate observation results of the surfaces of the solid electrolyte layers in the electrode assemblies manufactured according to Example 1 and Comparative examples 1 and 3.

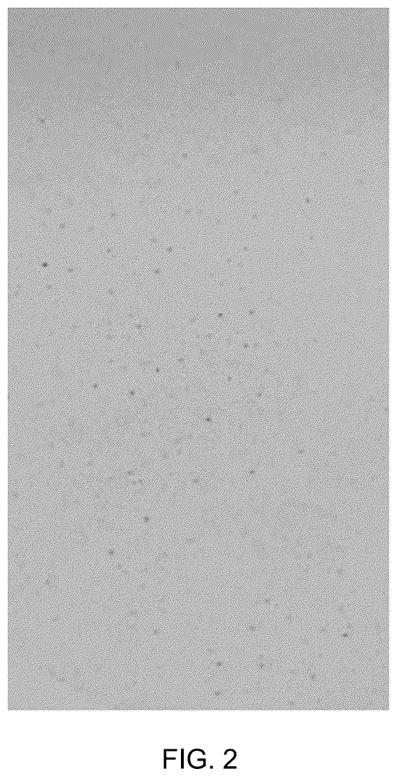

It may be recognized from FIG. 1 and FIG. 2 that a larger amount of air bubbles were formed on the surface of the solid electrolyte layer in the electrode assembly according to Comparative example 1, while air bubbles were rarely formed on the surface of the solid electrolyte layer in the electrode assembly according to Example 1, such that a uniform and smooth surface is formed.

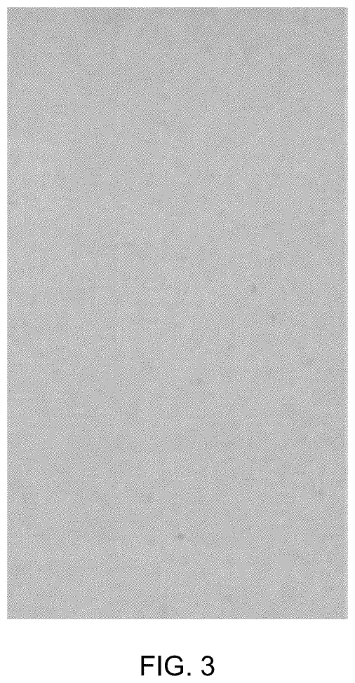

Even in FIG. 3 illustrating the observation result of the surface of the solid electrolyte layer in the electrode assembly manufactured with the degree of dryness of 70%, air bubbles were formed on the surface of the solid electrolyte layer, such that the electrolyte layer was partially convex up, which is similarly to FIG. 2.

### Experimental Example 2 Observation of SEM Image of Cross-Section in Electrode Assembly

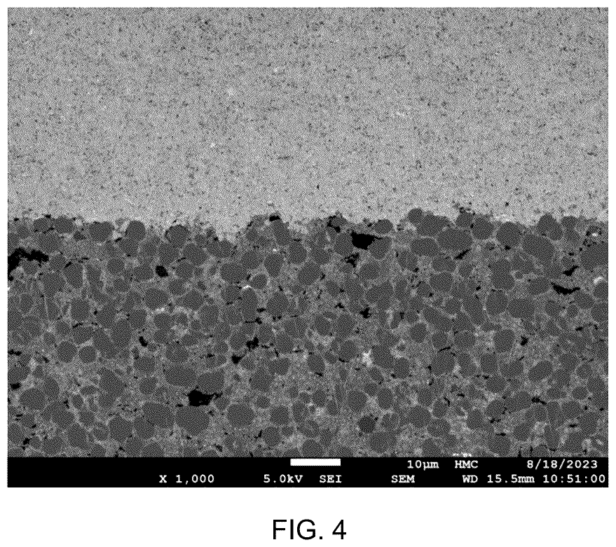

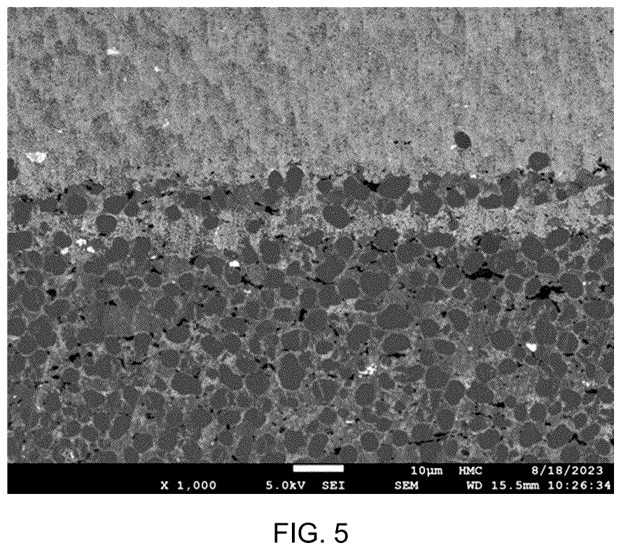

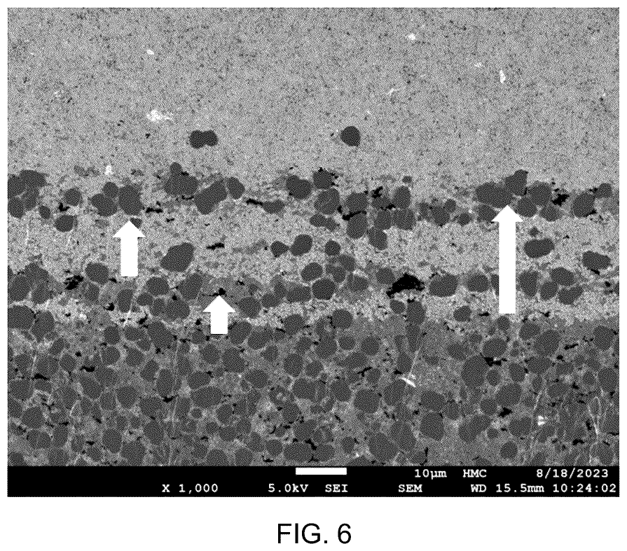

Cross sections of the electrode assemblies according to Examples 1 and 2, and Comparative example 2 were observed through SEM images, and the observation results are illustrated in FIGS. 4 to 6. JSM-7610FPlus, which is JEOL's model name, was used as equipment to observe the SEM image.

For the electrode assembly according to Example 1, the inter-layer mixing was hardly made between the solid electrolyte layer and the electrode layer, such that the interface between two layers was clearly recognized. Even for the electrode assembly according to Example 2, the interface between two layers was clearly recognized even though the inter-layer mixing was slightly made. However, for the electrode assembly according to Comparative example 2, it may be recognized a delamination phenomenon in which a portion of the active material is moved to the solid electrolyte occurs as the solid electrolyte slurry was coated in the state that the electrode slurry is never dried, the inter-layer mixing between the two layers was made.

According to the present disclosure, in the method for manufacturing the electrode assembly for the all-solid state battery, the solid electrolyte slurry is coated on the electrode layer, and the result is dried to form the solid electrolyte layer, thereby implementing a more sufficient interface contact, as compared to the conventional transferring manner for making contact between the electrode layer and the solid electrolyte layer in the solid state. In addition, in the state that the electrode slurry is incompletely dried in the process of forming the electrode layer, the solid electrolyte slurry is coated and dried, thereby minimizing the inter-layer mixing between the electrode layer and the solid electrolyte layer while uniformly drying the solvent, such that the endurance performance of the cell is improved.

Hereinabove, although the present disclosure has been described with reference to exemplary examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for manufacturing an electrode assembly, the method comprising:
coating an electrode slurry on an electrode current collector,
partially drying the electrode slurry to a degree of dryness ranging from about 20% to about 50% to form an electrode layer;
coating a solid electrolyte slurry on the electrode layer formed; and
drying the solid electrolyte slurry,
wherein the degree of the dryness is calculated through following Equation 1,
$$Degree of dryness = \{ 1 - ( content of solvent in the electrode layer formed after the partial drying ) / ( content of solvent in the coated electrode slurry ) \} * 100 \% . \qquad [ Equation 1 ]$$

2. The method of claim 1, wherein a solid content of the electrode slurry ranges from about 40 wt % to about 80 wt %.

3. The method of claim 1, wherein a viscosity of the electrode slurry ranges from about 1,000 cP to about 10,000 cP.

4. The method of claim 1, wherein the partially drying the electrode slurry to a degree of dryness ranging from 20% to 50% is performed at a temperature ranging from about 60° C. to about 120° C.

5. The method of claim 1, wherein a solid content of the solid electrolyte slurry ranges from about 40 wt % to about 80 wt %.

6. The method of claim 1, wherein a viscosity of the solid electrolyte slurry ranges from about 1,000 cP to about 10,000 cP.

7. The method of claim 1, wherein a ratio of a viscosity of the solid electrolyte slurry to a viscosity of the electrode slurry ranges from about 0.2 to about 1.0.

8. The method of claim 1, wherein the drying the solid electrolyte slurry is performed at a temperature ranging from about 60° C. to about 120° C.

9. A method for manufacturing an electrode assembly, the method comprising:
providing an electrode slurry having a solid content of 40 wt % to 80 wt % and a viscosity of 1,000 cP to 10,000 cP at 25° C.;
coating the electrode slurry on a current collector;
partially drying the coated electrode slurry so that a degree of dryness is from about 20% to about 50% to form an incompletely dried electrode layer,
providing a solid electrolyte slurry having a solid content of 40 wt % to 80 wt % and a viscosity of about 1,000 cP to about 10,000 cP at 25° C.;
coating the solid electrolyte slurry on the incompletely dried electrode layer, and
drying the solid electrolyte slurry at a temperature ranging from about 60° C. to about 120° C.,
wherein a ratio of a viscosity of the solid electrolyte slurry to a viscosity of the electrode slurry is from about 0.2 to about 1.0, and
the degree of dryness is calculated by the following Equation (1):
$$Degree of dryness = \{ 1 - ( content of solvent in the electrode layer formed after the partial drying ) / ( content of solvent in the coated electrode slurry ) \} * 100 \% .$$

10. The method of claim 9, wherein partially drying the electrode slurry is performed at about 60° C. to 120° C. until the degree of dryness is about 20% to 50%.

11. The method of claim 9, further comprising, before coating the electrode slurry, preparing the electrode slurry by mixing:
a cathode active material,
a sulfide-based solid electrolyte powder,
a binder,
a conductive material, and
a solvent.

12. The method of claim 9, wherein said solid electrolyte slurry further comprises a sulfide-based solid electrolyte, a binder, and a solvent, and wherein the method includes controlling the ratio of solid electrolyte slurry viscosity to electrode slurry viscosity to about 0.2 to 1.0 at 25° C.

13. The method of claim 9, wherein the electrode layer is formed as a cathode layer having an NCM-type cathode active material of average particle size of about 1 μm to 50 μm.

14. The method of claim 9, wherein the drying the solid electrolyte slurry is performed at about 60° C. to 120° C. for about 1 to 30 minutes.

15. The method of claim 9, wherein the method further comprises controlling the partial drying to achieve about a 30% degree of dryness, thereby reducing inter-layer mixing while preventing surface irregularities of the solid electrolyte layer.

16. The method of claim 9, further comprising subjecting the completed electrode assembly to a calendering step under 1 MPa to 50 MPa of pressure at a temperature from about 25° C. to 80° C.

17. A method for producing an all-solid-state battery, comprising:
manufacturing an electrode assembly according to any one of claim 1,
forming an anode layer,
stacking the electrode assembly and the anode layer so that the solid electrolyte layer faces the anode, and
enclosing or sealing the stacked assembly in a battery casing to construct the all-solid-state battery.

18. The method of claim 17, wherein the anode layer is formed by coating an anode slurry comprising a carbon-based active material or a metal-based active material, and drying at about 60° C. to 120° C.

19. The method of claim 17, further comprising incorporating a separator layer between the electrode assembly and the anode layer, wherein said separator layer is formed from a solid electrolyte film of about 5 μm to 50 μm thickness.

20. The method of claim 17, further comprising an initial charging or formation cycle at room temperature to about 60° C. to stabilize the interface between the electrode assembly and the anode layer.
